(19) United States
(12) Patent Application Publication
(10) Pub. No.: US 2015/0177687 A1
(43) Pub. Date: Jun. 25, 2015

(54) HOLOGRAM RECORDING APPARATUS FOR RECORDING HOLOGRAPHIC ELEMENT IMAGES ON PARTITIONED HOLOGRAM FILM

(71) Applicant: Electronics and Telecommunications Research Institute, Daejeon (KR)

(72) Inventors: Bong Ho LEE, Daejeon (KR); Hyon Gon CHOO, Daejeon (KR); Tae One KIM, Daejeon (KR); Kwan Jung OH, Daejeon (KR); Kyung Ae MOON, Daejeon (KR); Jin Woong KIM, Daejeon (KR)

(21) Appl. No.: 14/576,654

(22) Filed: Dec. 19, 2014

(30) Foreign Application Priority Data
Dec. 19, 2013 (KR) 10-2013-0159499

(51) Int. Cl. G03H 1/12

(52) U.S. Cl. CPC G03H 1/12

(57) ABSTRACT

Provided is a hologram recording apparatus for recording holographic element images on a partitioned hologram film, the apparatus including at least one object beam converging lens system located in each partitioned region of a hologram film. The at least one object beam converging lens system may output a signal beam by modulating an object beam using holographic element images, and condense the signal beam to be incident to the hologram film.

### CROSS-REFERENCE TO RELATED APPLICATION

This application claims the benefit of Korean Patent Application No. 10-2013-0159499, filed on Dec. 19, 2013, in the Korean Intellectual Property Office, the disclosure of which is incorporated herein by reference.

### BACKGROUND

1. Field of the Invention

Embodiments of the present invention relate to a hologram recording apparatus that may record holographic element images on a partitioned hologram film, and more particularly, to an apparatus that may set a plurality of regions by partitioning a hologram film, and dispose at least one object beam converging lens system in each set region, thereby recording a plurality of holographic element images on the hologram film.

2. Description of the Related Art

Among existing methods of recording a hologram on a hologram film, a digital recording method refers to a method of generating an interference pattern for each holographic element, which is a small unit.

The digital recording method may have a hologram recording rate that varies based on a type of a laser and a method of transferring a film plate. For example, when a continuous wave (CW) laser is used, the hologram recording rate may decrease due to a pause after movement for each holographic element.

However, in view of an efficiency of the hologram recording apparatus, use of the CW layer may be relatively advantageous in terms of size and economic feasibility. Herein, an apparatus that may quickly record a hologram using a CW laser will be described.

### SUMMARY

An aspect of the present invention provides an apparatus that may set a plurality of regions by partitioning a hologram film, and dispose at least one object beam converging lens system in each set region, thereby recording a plurality of holographic element images simultaneously on the hologram film.

According to an aspect of the present invention, there is provided a hologram recording apparatus including at least one object beam converging lens system located in each partitioned region of a hologram film. The at least one object beam converging lens system may output a signal beam by modulating an object beam using a holographic element image, and condense the output signal beam to be incident to the hologram film.

The apparatus may further include a film transfer unit to transfer a partitioned region of the hologram film to a location at which the at least one object beam converging lens system is located. The film transfer unit may transfer the hologram film within a range in which the at least one object beam converging lens system is not located out of the partitioned region.

The at least one object beam converging lens system may include a spatial light modulator (SLM) to output a signal beam by modulating an object beam using a holographic element image, a polarized beam splitter (PBS) to transmit the object beam to the SLM, a relay lens to control a diameter of the signal beam output by the SLM, and a converging lens to condense the diameter-controlled signal beam to be incident to the hologram film.

According to another aspect of the present invention, there is also provided a hologram recoding apparatus including a recording light source unit to split a source beam output from a light source into a first output beam and a second output beam, and output the first output beam and the second output beam, a reference beam generator to eliminate a distortion of the first output beam, and generate a reference beam by controlling a diameter and a shape of the distortion-eliminated first output beam, an object beam generator to generate an object beam by eliminating a distortion of the second output beam, and at least one object beam converging lens system to output a signal beam by modulating the object beam using a holographic element image, and condense the output signal beam to be incident to a hologram film. The signal beam may form an interference pattern through interference with the reference beam. The hologram film may be partitioned into a plurality of regions, and the at least one object beam converging lens system is located in each partitioned region.

The apparatus may further include a controller to transmit a holographic element image corresponding to each partitioned region to the at least one object beam converging lens system located in each partitioned region, and the at least one object beam converging lens system may modulate the object beam using the received holographic element image, and transmit the modulated object beam to the hologram film.

The object beam generator may eliminate the distortion of the second output beam using a beam expander (BE), a spatial filer (SF), and a micro lens array (MLA). The reference beam generator may generate the reference beam by eliminating the distortion of the first output beam using a BE and an SF, control a diameter and a shape of the generated reference beam, and transmit the diameter and size-controlled reference beam to the hologram film.

The reference beam generator may control the diameter of the reference beam using at least one mirror, at least one wave plate, and at least one polarizer, and control the shape of the reference beam using an aperture.

The reference beam generator may control the diameter of the reference beam using a relay lens, and control the shape of the reference beam using an aperture.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 illustrates a hologram recording apparatus according to an embodiment of the present invention;

FIG. 2 illustrates a configuration of a recording light source unit according to an embodiment of the present invention;

FIG. 3 illustrates a configuration of a recording light source unit according to another embodiment of the present invention;

FIG. 4 illustrates a configuration of a reference beam generator according to an embodiment of the present invention;

FIG. 5 illustrates a configuration of an object beam generator according to an embodiment of the present invention;

FIG. 6 illustrates a configuration of an object beam converging lens system according to an embodiment of the present invention;

FIG. 7 illustrates a configuration of an object beam converging lens system according to another embodiment of the present invention;

FIG. 8 illustrates an example of a hologram recording apparatus according to an embodiment of the present invention;

FIG. 9 illustrates an example of disposition of an object beam converging lens system according to an embodiment of the present invention; and

FIGS. 10A and 10B illustrate examples of a method of transferring a hologram film according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures. A hologram recording method according to an embodiment of the present invention may be performed by a hologram recording apparatus.

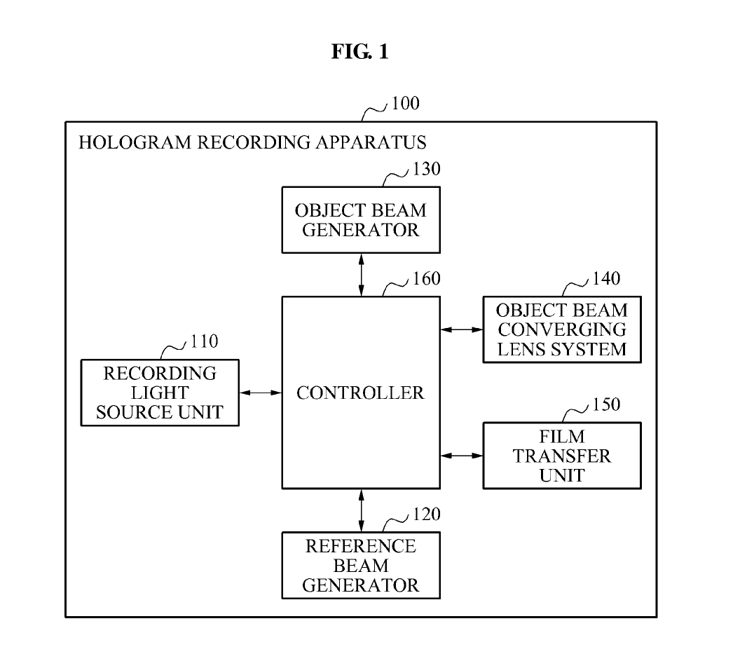

FIG. 1 illustrates a hologram recording apparatus 100 according to an embodiment of the present invention.

Referring to FIG. 1, the hologram recording apparatus 100 may include a recording light source unit 110, a reference beam generator 120, an object beam generator 130, an object beam converging lens system 140, a film transfer unit 150, and a controller 160.

The hologram recording apparatus 100 may partition a hologram film into a plurality of regions, and at least one object beam converging lens system 140 may be located in each partitioned region.

The recording light source unit 110 may split a source beam output from a light source into a first output beam and a second output beam and output the first output beam and the second output beam. The recording light source unit 110 may include a coherence light source, for example a laser. For example, the recording light source unit 110 may use a red (R) laser, a green (G) laser, and a blue (B) laser as light sources. A type of a laser used as a light source by the recording light source unit 110 may correspond to a continuous wave (CW) laser.

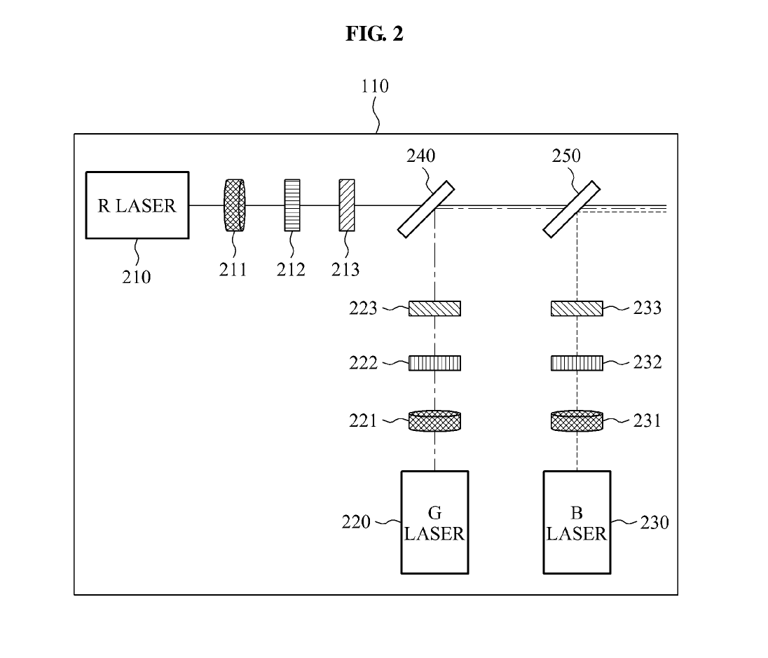

When an optical axis of the first output beam and the second output beam output to the reference beam generator 120 and the object beam generator 130 corresponds to a single optical axis, the recording light source unit 110 may combine source beams output by the R laser, the G laser, and the B laser into a single light using a beam combiner, and split the single light into a first output beam and a second output beam, as illustrated in FIG. 2.

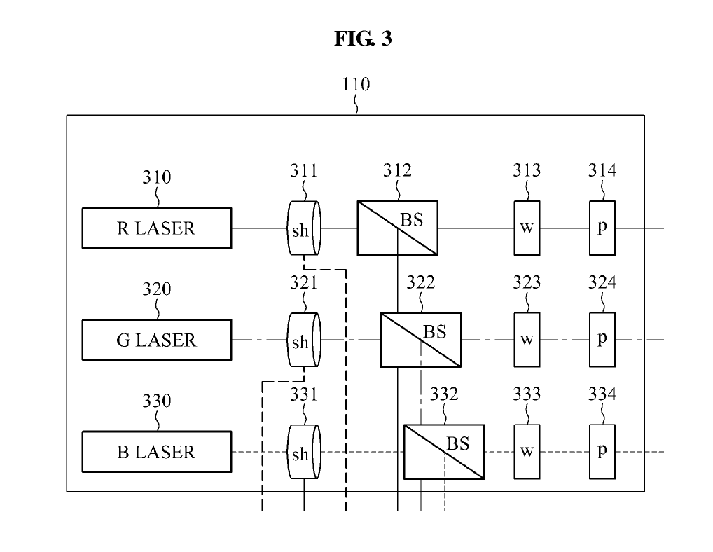

The recording light source unit 110 may also individually split source beams output by the R laser, the G laser, and the B laser, as illustrated in FIG. 3.

Configurations of the recording light source unit 110 will be described in detail with reference to FIGS. 2 and 3.

The reference beam generator 120 may eliminate a distortion of the first output beam. The reference beam generator 120 may generate a reference beam by controlling a diameter and a shape of the distortion-eliminated first output beam.

The reference beam generator 120 may control the diameter of the distortion-eliminated first output beam using at least one mirror, at least one wave plate, and at least one polarizer, or control the diameter of the distortion-eliminated first output beam using a relay lens. The reference beam generator 120 may control the shape of the distortion-eliminated first output beam using an aperture.

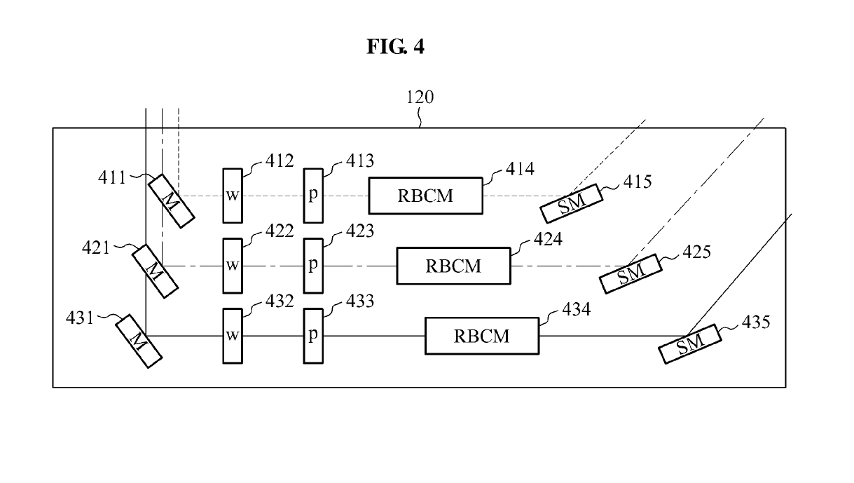

A configuration of the reference bam generator 120 will be described in detail with reference to FIG. 4.

The object beam generator 130 may generate an object beam being a collimated beam obtained by eliminating a distortion from the second output beam output by the recording light source unit 110.

The object beam generator 130 may generate the object beam by eliminating a distortion of the second output beam using a beam expander (BE), a spatial filter (SF), and a micro lens array (MLA). The object beam generator 130 may include a polarizer, a wave plate, and a neutral density filter (NDF) to adjust an intensity of the generated object beam.

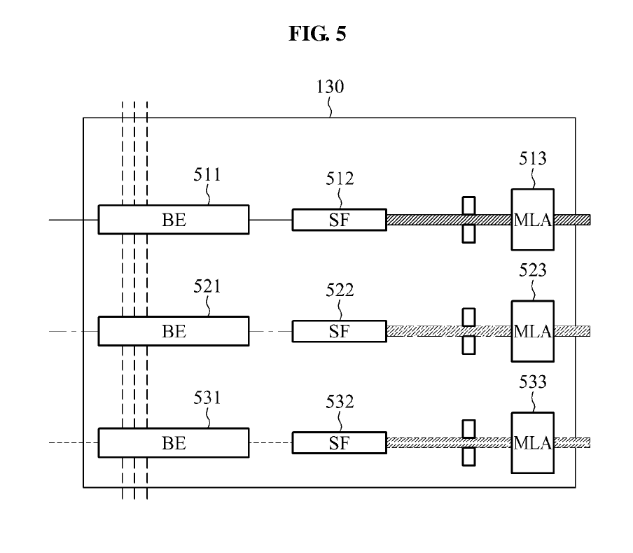

A configuration of the object beam generator 130 will be described in detail with reference to FIG. 5.

The at least one object beam converging lens system 140 may output a signal beam by modulating the generated object beam using a holographic element image provided by the controller 160. The at least one object beam converging lens system 140 may condense the signal beam to be incident to a hologram film.

The signal beam incident to the hologram film may form an interference pattern through interference with the reference beam incident to the hologram film, whereby a hologram may be recorded on the hologram film.

The object beam converging lens system 140 may include a spatial light modulator (SLM), a relay lens, and a converging lens for each object beam output by the object beam generator 130.

The object beam converging lens system 140 may include one of a reflective SLM and a transmissive SLM. When the object beam converging lens system 140 includes a reflective SLM, the object beam converging lens system 140 may further include a polarized beam splitter (PBS) to transmit the object beam output by the object beam generator 130 to the SLM.

The SLM may display a holographic element image received from the controller 160 on a display. The object beam incident to the SLM may be modulated and reflected based on the holographic element image displayed on the display. A signal beam being the modulated and reflected object beam may proceed in a direction of a hologram film. For example, the signal beam may correspond to an object beam modulated to have an intensity of each pixel in a holographic element image.

When the object beam converging lens system 140 includes a transmissive SLM, the object beam output by the object beam generator 130 may be modulated and changed to a signal beam while penetrating through the SLM, and the signal beam may be incident to the relay lens.

The SLM may display a holographic element image received from the controller 160 on a transparent display through which an object beam may penetrate. The object beam output by the object beam generator 130 may be modulated based on the holographic element image displayed on the transparent display while penetrating through the transparent display of the SLM.

The relay lens may control a diameter of the signal beam being the object beam modulated by the SLM. For example, when a holographic element having a size of 1 millimeter (mm)×1 mm is to be recorded on a hologram film, a diameter of a signal beam to be incident to a surface of the hologram film is to be 1 mm×1 mm However, a diameter of a signal beam output by the SLM may not correspond to 1 mm×1 mm Thus, the relay lens may control the diameter of the signal beam output by the SLM based on the size of the hologram element.

A type of the relay lens may be determined based on the size of the holographic element to be recorded on the hologram film and the diameter of the signal beam output by the SLM.

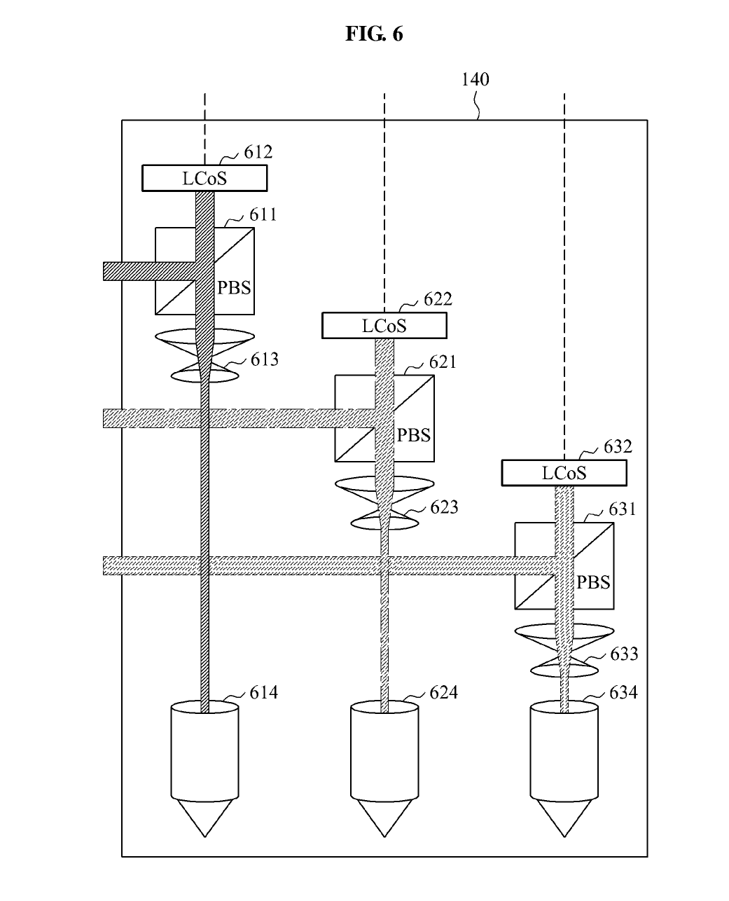

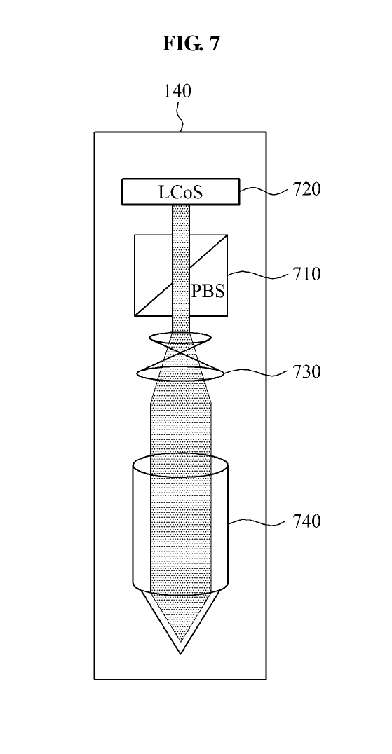

When the size of the holographic element is smaller than the diameter of the signal beam output by the SLM, the object beam converging lens system 140 may include a relay lens configured to reduce a diameter of a signal beam, as illustrated in FIG. 6. When the size of the holographic element is greater than the diameter of the signal beam output by the SLM, the object beam converging lens system 140 may include a relay lens configured to increase a diameter of a signal beam, as illustrated in FIG. 7.

Only when a signal beam incident to the relay lens corresponds to a distortion-less collimated light, a distortion resulting from a change in diameter may be prevented.

The converging lens may receive the diameter-controlled signal beam, and condense the received signal beam at a field of view (FOV) angle to be incident to the hologram film.

Configurations of the object beam converging lens system 140 will be described in detail with reference to FIGS. 6 and 7.

The film transfer unit 150 may transfer a partitioned region of the hologram film to a location at which the at least one object beam converging lens system 140 is located.

The at least one object beam converging lens system 140 located at the location to which the hologram film is transferred by the film transfer unit 150 may correspond to at least one object beam converging lens system 140 configured to output a signal beam using a holographic element image to be recorded on a hologram film.

The film transfer unit 150 may fix the hologram film, and transfer the fixed hologram film to the location at which the object beam converging lens system 140 is located. The film transfer unit 150 may include at least one axis transfer motor to transfer the hologram film.

Since the holographic element image may be two-dimensionally recorded on the hologram film, the film transfer unit 150 may include an X-axis motor and a Y-axis motor, in general. The film transfer unit 150 may further include a Z-axis motor to control a distance between the hologram film and the at least one object beam converging lens system 140 by adjusting a height of the film transfer unit 150.

The film transfer unit 150 may transfer the hologram film using one of a step method, a roll-fed method, and a scanning method.

The controller 160 may control operations of the recording light source unit 110, the reference beam generator 120, the object beam generator 130, and the object beam converging lens system 140, and the film transfer unit 150.

For example, the controller 160 may drive the recording light source unit 110 to output the first output beam and the second output beam to the reference beam generator 120 and the object beam generator 130, respectively. The controller 160 may control an optical shutter to control exposures of an object beam and a reference beam.

The controller 160 may transmit holographic element images corresponding to each partitioned region to the at least one object beam converging lens system 140 located in each partitioned region. The at least one object beam converging lens system 140 may modulate an object beam by outputting the holographic element images received from the controller 160 to the SLM, and outputting the object beam generated by the object beam generator 130.

The controller 160 may control a motor of the film transfer unit 150 to transfer the hologram film to a location of a desired object beam converging lens system 140. The controller 160 may additionally have a control function to control an optical component and photograph a beam.

The hologram recording apparatus 100 may set a plurality of regions by partitioning a hologram film, and dispose at least one object beam converging lens system 140 in each set region, thereby recording a plurality of holographic element images simultaneously on the hologram film.

FIG. 2 illustrates a configuration of the recording light source unit 110 according to an embodiment of the present invention.

In detail, FIG. 2 illustrates the configuration of the recording light source unit 110 in a case in which an optical axis of a first output beam and a second output beam output to the reference beam generator 120 and the object beam generator 130 corresponds to a single optical axis.

Referring to FIG. 2, the recording light source unit 110 may output red light output from an R laser 210, green light output from a G laser 220, and blue light output from a B laser 230 along a single optical axis using a first beam combiner 240 and a second beam combiner 250.

The recording light source unit 110 may adjust an intensity of the red light using a first optical shutter 211, a first wave plate 212, and a first polarizer 213. The recording light source unit 110 may adjust an intensity of the green light using a second optical shutter 221, a second wave plate 222, and a second polarizer 223. The recording light source unit 110 may adjust an intensity of the blue light using a third optical shutter 231, a third wave plate 232, and a third polarizer 233.

The recording light source 110 may combine the intensity-adjusted red light with the intensity-adjusted green light using the first beam combiner 240. The recording light source unit 110 may combine a source beam, in which the intensity-adjusted red light is combined with the intensity-adjusted green light, with the intensity-adjusted blue light using the second beam combiner 250.

The recording light source unit 110 may split the source beam combined along the single optical axis into a first output beam and a second output beam using a beam splitter (BS) (not shown).

FIG. 3 illustrates a configuration of the recording light source unit 110 according to another embodiment of the present invention.

In detail, FIG. 3 illustrates the configuration of the recording light source unit 110 using red light output from an R laser 310, green light output from a G laser 320, and blue light output from a B laser 330 as independent source beams.

The recording light source unit 110 may adjust an intensity of the red light using a first optical shutter 311 indicated by sh, and split the intensity-adjusted red light into a first output beam and a second output beam using a first BS 312. The first output beam split by the first BS 312 may be output to the reference beam generator 120. The recording light source unit 110 may adjust an intensity of the second output beam split by the first BS 312 using a first wave plate 313 indicated by w and a first polarizer 314 indicated by p.

The recording light source unit 110 may adjust an intensity of the green light using a second optical shutter 321 indicated by sh, and split the intensity-adjusted green light into a first output beam and a second output beam using a second BS 322. The first output beam split by the second BS 322 may be output to the reference beam generator 120. The recording light source unit 110 may adjust an intensity of the second output beam split by the second BS 322 using a second wave plate 323 indicated by w and a second polarizer 324 indicated by p.

The recording light source unit 110 may adjust an intensity of the blue light using a third optical shutter 331 indicated by sh, and split the intensity-adjusted blue light into a first output beam and a second output beam using a third BS 332. The first output beam split by the third BS 332 may be output to the reference beam generator 120. The recording light source unit 110 may adjust an intensity of the second output beam split by the third BS 332 using a third wave plate 333 indicated by w and a third polarizer 334 indicated by p.

FIG. 4 illustrates a configuration of the reference beam generator 120 according to an embodiment of the present invention.

In detail, FIG. 4 illustrates an example of the reference beam generator 120 controlling diameters of first output beams split from red light, green light, and blue light using at least one mirror, at least one wave plate, and at least one polarizer.

Referring to FIG. 4, the reference beam generator 120 may change a proceed direction of a first output beam output by the recording light source unit 110 using a first mirror 411. The first output beam may correspond to the first output beam split from the blue light by the third BS 332.

The reference beam generator 120 may adjust an intensity of the proceed direction-changed first output beam using a first wave plate 412 and a first polarizer 413. The reference beam generator 120 may include an NDF, in lieu of the first wave plate 412 and the first polarizer 413, to adjust the intensity of the first output beam.

The reference beam generator 120 may eliminate a distortion of the first output beam using a first reference beam control module (RBCM) 414, and generate a reference beam by controlling a diameter and a shape of the distortion-eliminated first output beam.

In this example, the first RBCM 414 may include a BE, an SF, and at least one relay lens array. The first RBCM 414 may generate a reference beam being a collimated beam by eliminating the distortion of the first output beam using the BE and the SF. The first RBCM 414 may control a diameter and a shape of the generated reference beam using the relay lens array, and output the diameter and shape-controlled reference beam.

The reference beam generator 120 may transmit the reference beam to a hologram film using a first reference beam steering mirror 415 indicated by SM. When an angle of incidence of the reference beam transmitted to the hologram film using the first reference beam steering mirror 415 differs from an angle of incidence of the reference beam transmitted to the hologram film using a second reference beam steering mirror 425 and an angle of incidence of the reference beam transmitted to the hologram film using a third reference beam steering mirror 435, red, green, and blue (RGB) beams may not be placed at an identical point on the hologram film and thus, a color distortion may occur during hologram reproduction. Accordingly, the reference beam generator 120 may adjust, using at least one mirror, the angle of incidence and a location of incidence of the reference beam at which the reference beam is transmitted to the hologram film using the first reference beam steering mirror 415.

The diameter and the shape of the reference beam may be controlled based on a size of a preset holographic element before the reference beam is incident to the hologram film. Thus, the reference beam generator 120 may include an aperture through which the reference beam reflected by the first reference beam steering mirror 415 passes before the reference beam is incident to the hologram film. The aperture may control the diameter of the reference beam based on the size of the holographic element.

The reference beam generator 120 may change a proceed direction of a first output beam output by the recording light source unit 110 using a second mirror 421. The first output beam may correspond to the first output beam split from the green light by the second BS 322.

The reference beam generator 120 may adjust an intensity of the proceed direction-changed first output beam using a second wave plate 422 and a second polarizer 423. The reference beam generator 120 may eliminate a distortion of the first output beam using a second RBCM 424, and generate a reference beam by controlling a diameter and a shape of the distortion-eliminated first output beam. A configuration and an operation of the second RBCM 424 may be identical to those of the first RBCM 414.

The reference beam generator 120 may transmit the reference beam to the hologram film using the second reference beam steering mirror 425 indicated by SM. The reference beam generator 120 may adjust, using at least one mirror, an angle of incidence and a location of incidence of the reference beam at which the reference beam is transmitted to the hologram film using the second reference beam steering mirror 425.

The reference beam generator 120 may change a proceed direction of a first output beam output by the recording light source unit 110 using a third mirror 431. The first output beam may correspond to the first output beam split from the red light by the first BS 312.

The reference beam generator 120 may adjust an intensity of the proceed direction-changed first output beam using a third wave plate 432 and a third polarizer 433.

The reference beam generator 120 may eliminate a distortion of the first output beam using a third RBCM 434, and generate a reference beam by controlling a diameter and a shape of the distortion-eliminated first output beam. A configuration and an operation of the third RBCM 434 may be identical to those of the first RBCM 414.

The reference beam generator 120 may transmit the reference beam to the hologram film using the third reference beam steering mirror 435 indicated by SM. The reference beam generator 120 may adjust, using at least one mirror, an angle of incidence and a location of incidence of the reference beam at which the reference beam is transmitted to the hologram film using the third reference beam steering mirror 435.

FIG. 5 illustrates a configuration of the object beam generator 130 according to an embodiment of the present invention.

In detail, FIG. 5 illustrates an example of the object beam generator 130 generating object beams by separately eliminating distortions of second output beams split from red light, green light, and blue light.

Referring to FIG. 5, the object beam generator 130 may generate an object beam by eliminating a distortion of a second output beam using a BE, an SF, and an MLA.

A first BE 511 and a first SF 512 may generate an object beam by eliminating a distortion of a second output beam output by the recording light source unit 110. The second output beam may correspond to the second output beam split from the red light by the first BS 312. The generated object beam may have a Gaussian distribution and a nonuniform shape.

A first MLA 513 may correct the shape of the generated object beam to be uniform, and output the shape-corrected object beam. The first MLA 513 may be an MLA corresponding to characteristics of an SLM to which the object beam is to be incident. For example, the first MLA 513 may be an MLA selected based on a pixel pitch and a diameter of a beam required by the SLM.

A second BE 521 and a second SF 522 may generate an object beam by eliminating a distortion of a second output beam output by the recording light source unit 110. The second output beam may correspond to the second output beam split from the green light by the second BS 322.

A second MLA 523 may correct a shape of the generated object beam to be uniform, and output the shape-corrected object beam. The second MLA 523 may be an MLA corresponding to characteristics of an SLM to which the object beam is to be incident.

A third BE 531 and a third SF 532 may generate an object beam by eliminating a distortion of a second output beam output by the recording light source unit 110. The second output beam may correspond to the second output beam split from the blue light by the third BS 332.

A third MLA 533 may correct a shape of the generated object beam to be uniform, and output the shape-corrected object beam. The third MLA 533 may be an MLA corresponding to characteristics of an SLM to which the object beam is to be incident.

FIG. 6 illustrates a configuration of the object beam converging lens system 140 according to an embodiment of the present invention.

In detail, FIG. 6 illustrates an example of the object beam converging lens system 140 including reflective SLMs to transmit object beams split from red light, green light, and blue light to a hologram film.

Referring to FIG. 6, a first PBS 611 may reflect an object beam output by the object beam generator 130 in a vertical direction to be incident to a first SLM 612. The object beam output by the object beam generator 130 may correspond to the object beam output by the first MLA 513.

The first SLM 612 may display a holographic element image received from the controller 160 on a display. The object beam incident to the first SLM 612 may be reflected on the display of the first SLM 612 to proceed in a direction of the hologram film. The reflected object beam may be modulated based on the displayed holographic element image. The display of the first SLM 612 may correspond to a liquid crystal on display (LCOS). The first SLM 612 may output a signal beam being the object beam modulated based on the holographic element image.

A first relay lens 613 may reduce a diameter of the output signal beam based on a size of a preset holographic element.

A first converging lens 614 may condense the diameter-reduced signal beam at an FOV angle to be incident to the hologram film.

A second PBS 621 may reflect an object beam output by the object beam generator 130 in a vertical direction to be incident to a second SLM 622. The object beam output by the object beam generator 130 may correspond to the object beam output by the second MLA 523.

The second SLM 622 may display a holographic element image received from the controller 160 on a display. The object beam incident to the second SLM 622 may be reflected on the display of the second SLM 622 to proceed in a direction of the hologram film. The reflected object beam may be modulated based on the displayed holographic element image. The second SLM 622 may output a signal beam being the object beam modulated based on the holographic element image.

A second relay lens 623 may reduce a diameter of the output signal beam based on a size of a preset holographic element.

A second converging lens 624 may condense the diameter-reduced signal beam at an FOV angle to be incident to the hologram film.

A third PBS 631 may reflect an object beam output by the object beam generator 130 in a vertical direction to be incident to a third SLM 632. The object beam output by the object beam generator 130 may correspond to the object beam output by the third MLA 533.

The third SLM 632 may display a holographic element image received from the controller on a display. The object beam incident to the third SLM 632 may be reflected on the display of the third SLM 632 to proceed in a direction of the hologram film. The reflected object beam may be modulated based on the displayed holographic element image. The third SLM 632 may output a signal beam being the object beam modulated based on the holographic element image.

A third relay lens 633 may reduce a diameter of the output signal beam based on a size of a preset holographic element.

A third converging lens 634 may condense the diameter-reduced signal beam at an FOV angle to be incident to the hologram film.

FIG. 7 illustrates a configuration of an object beam converging lens system according to another embodiment of the present invention.

In detail, FIG. 7 illustrates an example of the object beam converging lens system 140 in a case in which a diameter of an object beam generated by the object beam generator 130 is smaller than a size of a holographic element.

Referring to FIG. 7, a PBS 710 may reflect an object beam output by the object beam generator 130 in a vertical direction to be incident to an SLM 720.

The SLM 720 may display a holographic element image received from the controller 160 on a display. The object beam incident to the SLM 720 may be reflected on the display of the SLM 720 to proceed in a direction of a hologram film. The reflected object beam may be modulated based on the displayed holographic element image. The SLM 720 may output a signal beam being the object beam modulated based on the holographic element image.

A relay lens 730 may increase a diameter of the output signal beam based on a size of a preset holographic element.

A converging lens 740 may condense the diameter-increased signal beam at an FOV angle to be incident to the hologram film.

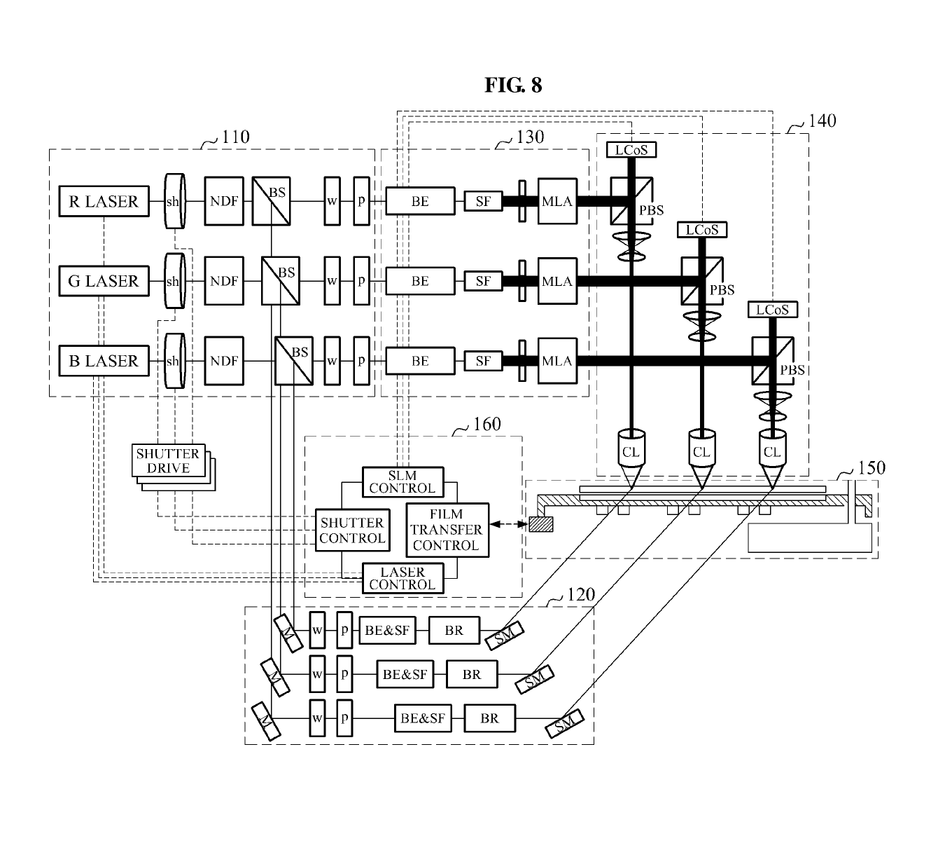

FIG. 8 illustrates an example of the hologram recording apparatus 100 according to an embodiment of the present invention.

Referring to FIG. 8, the recording light source unit 110 of the hologram recording apparatus 100 may split each of red light, green light, and blue light output by an R laser, a G laser, and a B laser into a first output beam and a second output beam. The recording light source unit 110 may output the first output beam to the reference beam generator 120, and output the second output beam to the object beam generator 130.

The reference beam generator 120 may generate a reference beam based on the first output beam output by the recording light source unit 110, and transmit the generated reference beam to a hologram film fastened to the film transfer unit 150.

The object beam generator 130 may generate an object beam based on the second output beam output by the recording light source unit 110, and output the generated object beam to the object beam converging lens system 140. The object beam converging lens system 140 may display a holographic element image on a liquid crystal on display (LCOS) of the SLM, and condense the output signal beam to be incident to the hologram film. The signal beam incident from the object beam converging lens system 140 may form an interference pattern on the hologram film through interference with the reference beam incident from the reference bam generator 120.

The controller 160 may control an optical component, a stage of the film transfer unit 150, and the SLM in a preset sequence so that signal beams may sequentially be incident to the hologram film using a holographic element image during a hologram recording process.

A method of recording a holographic element by forming a single-colored interference pattern on a hologram film using the G laser will be described in detail.

The green light output by the G laser may reach a BS only at a moment at which the shutter is open or close. In this example, an NDF configured to adjust an intensity of the green light being an output beam may be included between the G laser and the BS. The NDF may precisely adjust an intensity of the green light output by the G laser. The green light incident to the BS may be assumed to be a point source of light that outputs a beam with an excessively small diameter.

The green light may be split 50-50 by the BS, and output to the reference beam generator 120 and the object beam generator 130. Among the split green light, light output to the reference beam generator 120 may be referred to as a first output beam, and light output to the object beam generator 130 may be referred to as a second output beam.

The first output beam may be generated as a reference beam of which a size is adjusted based on a size of a holographic element image by an RBCM of the reference beam generator 120. The RB CM may generate the reference beam suitable to the size of the holographic element by applying beam expansion or reduction, and elimination through an SF to the first output beam. In addition, an angle of incidence at which the reference beam is to be incident to the hologram film may be adjusted by a reference beam steering mirror. The adjusted angle of incidence may correspond to an angle at which the reference beam may be absorbed optimally into the hologram film.

An intensity and a polarization direction of the second output beam may be adjusted using a wave plate and a polarizer of the object beam generator 130.

The intensity and polarization direction-adjusted second output beam may reach a BE of the object beam generator 130, be expanded to be a beam having a predetermined radius, and reach an SF. The predetermined radius may correspond to a size covering a diameter of the SLM.

The SF including a pinhole and a lens may eliminate, from the second output beam, a beam unable to pass through the pinhole, for example, noise.

The noise-eliminated second output beam may be reconstructed to be a distortion-eliminated object beam through an MLA, and incident to a PBS of the object beam converging lens system 140.

The object beam incident to the PBS may be incident to an LCoS of the SML based on a polarization direction set in the PBS. The object beam incident to the LCoS may be reflected on the LCoS and modulated using a holographic element image displayed on the LCoS. A signal beam being the modulated object beam may pass through the PBS to be incident to a relay lens. When the object beam incident to the LCoS corresponds to an S-wave, the signal beam reflected on the LCoS may correspond to a P-wave.

A diameter of the signal beam incident to the relay lens may be reduced linearly without distortion by the relay lens, and the diameter-reduced signal beam may be incident to a converging lens.

The signal beam incident to the converging lens may be expanded to be suitable for an angle of view of the converging lens, and the signal beam with a diameter corresponding to a size of a preset holographic element may be incident to the hologram film. The object beam incident to the hologram film may form an interference pattern, for example, a fringe pattern, through interference with the reference beam. The angle of view may be identical to an angle of diffraction at which light is diffracted by a single holographic element in a hologram recorded on a hologram film.

An aperture configured to minimize noise and a distortion of a beam may be located on paths of an object beam and a reference beam in the hologram recording apparatus 100, whereby qualities of the object beam and the reference beam may increase.

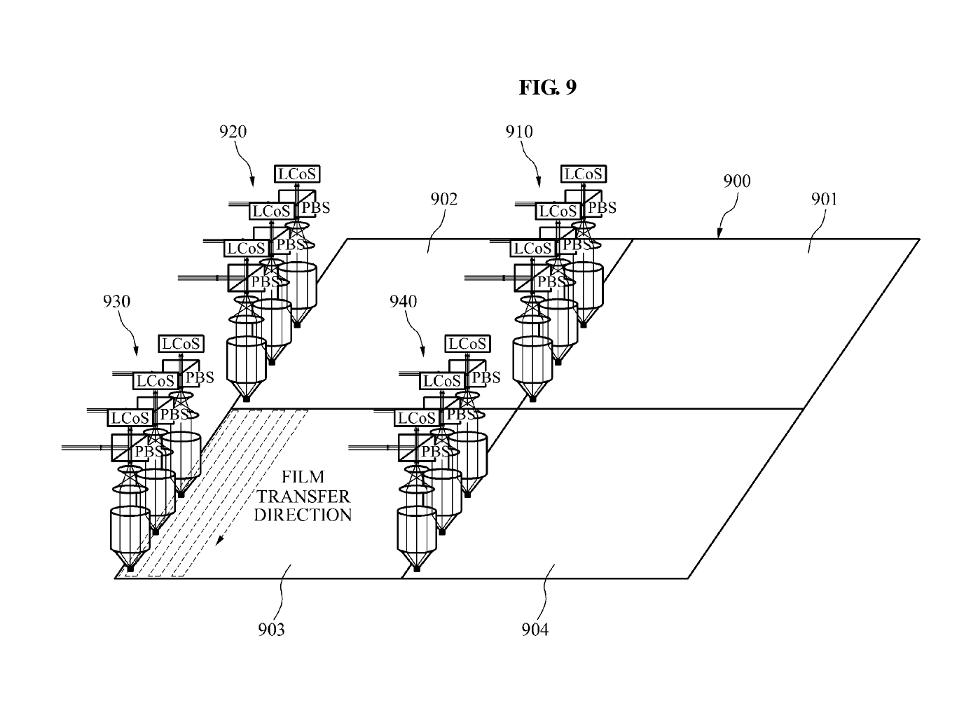

FIG. 9 illustrates an example of disposition of the object beam converging lens system 140 according to an embodiment of the present invention.

Referring to FIG. 9, the hologram recording apparatus 100 may partition a hologram film 900 into a plurality of regions. The hologram recording apparatus 100 may dispose at least one object beam converging lens system 140 in each partitioned region, thereby recording a plurality of holographic elements simultaneously.

For example, the hologram recording apparatus 100 may dispose a single object beam converging lens system 140 in each partitioned region of the hologram film 900. Partitioned regions of the hologram film 900 may include a first region 901, a second region 902, a third region 903, and a fourth region 904.

In detail, a first object beam converging lens system 910 may be located in the first region 901, a second object beam converging lens system 920 may be located in the second region 902, a third object beam converging lens system 930 may be located in the third region 903, and a fourth object beam converging lens system 940 may be located in the fourth region 904. Each of the first object beam converging lens system 910, the second object beam converging lens system 920, the third object beam converging lens system 930, and the fourth object beam converging lens system 940 may include SLMs, PBSs, relay lenses, and converging lenses corresponding to three beams, for example, RGB beams, respectively.

Accordingly, the hologram recording apparatus 100 may record twelve holographic elements simultaneously.

When compared to a hologram recording apparatus according to a related art that may record three holographic elements at a time using SMLs, PBSs, relay lenses, and converging lenses corresponding to the three beams, for example, RGB beams, respectively, the hologram recording apparatus 100 may record holographic elements at a quadrupled rate.

The hologram recording apparatus 100 may partition the hologram film 900 into sixteen regions, and dispose an object beam converging lens system in each partitioned region, thereby recording holographic elements at a sixteen times faster rate than the hologram recording apparatus according to the related art. In this example, the object beam converging lens system may include SLMs, PBSs, relay lenses, and converging lenses corresponding to the three beams, for example, RGB beams.

The controller 160 may provide a holographic element image to each LCoS included in the SLMs of the first object beam converging lens system 910, the second object beam converging lens system 920, the third object beam converging lens system 930, and the fourth object beam converging lens system 940. For example, the controller 160 may simultaneously provide twelve holographic element images to the LCoSs included in the

SLMs of the first object beam converging lens system 910, the second object beam converging lens system 920, the third object beam converging lens system 930, and the fourth object beam converging lens system 940.

The hologram recording apparatus 100 may dispose recording light source units 110, reference beam generators 120, and object beam generators 130 based on a number of the object beam converging lens systems 140 located in each region of a hologram film so that the recording light source units 110, the reference beam generators 120, and the object beam generators 130 may be in a one-to-one correspondence with the object beam converging lens systems 140.

In addition, the hologram recording apparatus 100 may enable the reference beam generator 120 to split a reference beam based on a number of the object beam converging lens systems 140 and transmit the split reference beams to a hologram film. The hologram recording apparatus 100 may enable the object beam generator 130 to split a generated object beam to be incident to the plurality of object beam converging lens systems 140. Thus, the hologram recording apparatus 100 may perform operations of the plurality of object beam converging lens systems 140 using the single recording light source unit 110, the single reference beam generator 120, and the single object beam generator 130.

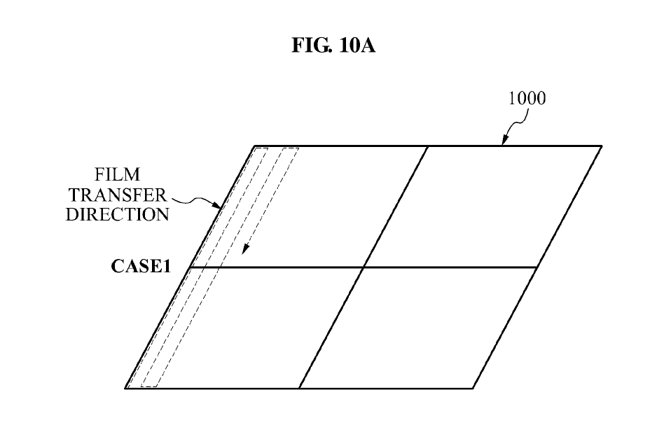

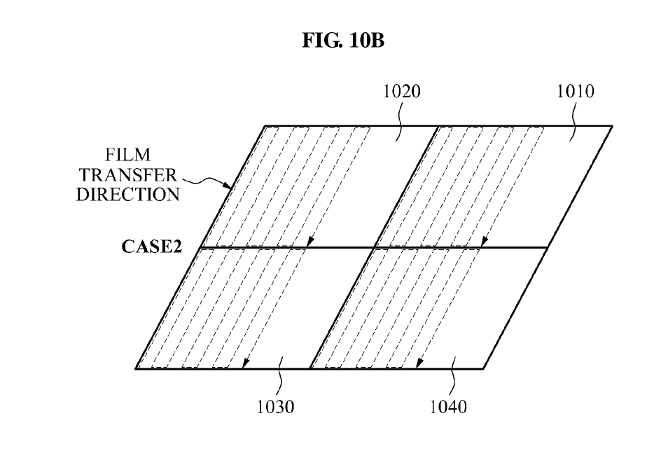

FIGS. 10A and 10B illustrate examples of a method of transferring a hologram film 1000 according to an embodiment of the present invention.

In FIGS. 10A and 10B, a broken line illustrates a process in which a location of an object beam incident to the hologram film 1000 is changed when the hologram film 1000 is transferred by a film transfer unit.

A hologram recording apparatus according to a related art may transmit an object beam to the hologram film 1000 using a single object beam converging lens system. Thus, as illustrated in Case 1 of FIG. 10A, a film transfer unit of the hologram recording apparatus according to the related art may transfer the hologram film 1000 so that the object beam converging lens system may pass through all regions of the hologram film 1000.

However, as illustrated in Case 2 of FIG. 10B, the hologram recording apparatus 100 may partition the hologram film 1000 into a first region 1010, a second region 1020, a third region 1030, and a fourth region 1040, and dispose the object beam converging lens system 140 in each partitioned region. Each object beam converging lens system 140 may record a holographic element on a region of the hologram film in which the corresponding object beam converging lens system 140 is located. Thus, the film transfer unit 150 may transfer the hologram film 1000 so that the object beam converging lens systems 140 may pass through only the respective regions.

Each region of the hologram film 1000 being a range in which the film transfer unit 150 transfers the hologram film 1000 may correspond to a quarter of the entire hologram film 1000. Thus, when the film transfer unit 150 transfers the hologram film 1000 an identical distance, the hologram recording apparatus according to the related art may record a hologram element on a portion of the hologram film 1000, whereas the hologram recording apparatus 100 may record more hologram elements in Case 2 than Case 1.

According to an embodiment of the present invention, it is possible to simultaneously record a plurality of holographic element images on a hologram film by partitioning the hologram film, set a plurality of regions on the hologram film, and disposing at least one object beam converging lens system in each set region.

In this example, hologram element images more than the partitioned regions of the hologram film may be recorded simultaneously on the hologram film and thus, it is possible to increase a rate at which holographic element images are recorded.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A hologram recording apparatus forming an interference pattern through interference between a signal beam and a reference beam output by modulating an object beam using a holographic element image, the apparatus comprising:
at least one object beam converging lens system located in each partitioned region of a hologram film, and
the at least one object beam converging lens system outputs a signal beam by modulating an object beam using a holographic element image, and converges the output signal beam to be incident to the hologram film.

2. The apparatus of claim 1, further comprising:
a film transfer unit to transfer a partitioned region of the hologram film to a location at which the at least one object beam converging lens system is located.

3. The apparatus of claim 1, further comprising:
a recording light source unit to split a source beam output from a light source into a first output beam and a second output beam, and output the first output beam and the second output beam;
a reference beam generator to eliminate a distortion of the first output beam, and generate a reference beam by controlling a diameter and a shape of the distortion-eliminated first output beam; and
an object beam generator to generate an object beam by eliminating a distortion of the second output beam,
wherein each partitioned region is located in at least one reference beam generator.

4. The apparatus of claim 1, wherein the at least one object beam converging lens system comprises:
a spatial light modulator (SLM) to output a signal beam by modulating an object beam using a holographic element image;
a polarized beam splitter (PBS) to transmit the object beam to the SLM;
a relay lens to control a diameter of the signal beam output by the SLM; and
a converging lens to condense the diameter-controlled signal beam to be incident to the hologram film.

5. A hologram recoding apparatus comprising:
a recording light source unit to split a source beam output from a light source into a first output beam and a second output beam, and output the first output beam and the second output beam;
a reference beam generator to eliminate a distortion of the first output beam, and generate a reference beam by controlling a diameter and a shape of the distortion-eliminated first output beam;
an object beam generator to generate an object beam by eliminating a distortion of the second output beam; and
at least one object beam converging lens system to output a signal beam by modulating the object beam using a holographic element image, and converging the output signal beam to be incident to a hologram film,
wherein the hologram film is partitioned into a plurality of regions, and each partitioned region is located in at least one reference beam converging lens system, and
the signal beam forms an interference pattern through interference with the reference beam.

6. The apparatus of claim 5, further comprising:
a film transfer unit to transfer a partitioned region of the hologram film to a location at which the at least one object beam converging lens system is located.

7. The apparatus of claim 5, wherein the at least one object beam converging lens system comprises:
a spatial light modulator (SLM) to output a signal beam by modulating an object beam using a holographic element image;
a polarized beam splitter (PBS) to transmit the object beam to the SLM;
a relay lens to control a diameter of the signal beam output by the SLM; and
a converging lens to converge the diameter-controlled signal beam to be incident to the hologram film.

8. The apparatus of claim 5, further comprising:
a controller to transmit a holographic element image corresponding to each partitioned region to the at least one object beam converging lens system located in each partitioned region,
wherein the at least one object beam converging lens system modulates the object beam using the received holographic element image, and transmits the modulated object beam to the hologram film.

9. The apparatus of claim 5, wherein the object beam generator eliminates the distortion of the second output beam using a beam expander (BE), a spatial filer (SF), and a micro lens array (MLA).

10. The apparatus of claim 5, wherein the reference beam generator generates the reference beam by eliminating the distortion of the first output beam using a BE(Beam Expander) and an SF(Spatial Filter), controls a diameter and a shape of the generated reference beam, and transmits the diameter and size-controlled reference beam to the hologram film.

11. The apparatus of claim 10, wherein the reference beam generator controls the diameter of the reference beam using at least one mirror, at least one wave plate, and at least one polarizer, and controls the shape of the reference beam using an aperture.

12. The apparatus of claim 10, wherein the reference beam generator controls the diameter of the reference beam using a relay lens, and controls the shape of the reference beam using an aperture.
